(19) United States
(12) Patent Application Publication
(10) Pub. No.: US 2015/0114231 A1
(43) Pub. Date: Apr. 30, 2015

(54) Air Treatment Device

(71) Applicant: Reckitt & Colman (Overseas) Limited, Slough (GB)

(72) Inventors: Andrea Conyers, Leven (GB); Reuben GARCIA, Barcelona (ES); Juan Antonio GOMEZ, Barcelona (ES); Benjamin David HINDLE, Ridgewood, NJ (US); Melanie ROPIC, Hull (GB); Steve WALSH, Camberley (GB)

(21) Appl. No.: 14/586,278

(22) Filed: Dec. 30, 2014

Related U.S. Application Data
(63) Continuation of application No. 13/265,679, filed on Oct. 21, 2011.

(30) Foreign Application Priority Data
Apr. 24, 2009 (GB) 0907049.1

(51) Int. Cl. B01D 46/00; B01D 46/42

(52) U.S. Cl. CPC B01D 46/0038; B01D 46/4263; B01D 46/0002
USPC 96/222

(57) ABSTRACT

An air treatment device is described comprising: a housing having at least one air inlet and at least one air outlet with at least two discrete air passageways therebetween; wherein in a first of said passageways there is located a fan and at least one air filter retaining means arranged to releasably retain, in use, an air filter within one passageway; and wherein in a second of said passageways there is located at least one refill securing means arranged to releasably securing a refill of air treatment agent and emanation means in the form of one or more heaters; and wherein, in use, airflow through said at least two passageways is separate.

### FIELD OF THE INVENTION

The present invention relates to a device for treating the air and particularly but not exclusively, for treating the air to remove contaminants and/or malodour therefrom as well as introduce an air treatment agent thereto.

### BACKGROUND

Increasing the amount of indoor air pollution is being linked to the affects it may have on a person's health. Certain studies suggest that indoor air can be significantly more polluted than outdoor air which may be of particular concern to people spending a majority of their time indoors.

Consequently it has become increasingly desirable to treat the air in localized environments to not only improve its perceived quality but also its actual quality by attempting to remove some of the more common indoor air pollutants, including dust, smoke, pollen, bacteria, soot, mould spores, animal dander, and other microscopic irritants, as well as attempting to remove malodour and thereby create a clean, healthy, fresh, and pleasant environment.

Air purifying devices are well known in general, and although such devices are considered to improve actual air quality it is not easy for a consumer to believe that they are particularly efficacious since they tend not to dramatically improve the perceived air quality.

Conversely, fragrancing is well know to be effective in improving the perceived air quality, but it is not considered from a consumer perspective to be particularly effective against the underlying causes which impaired the air quality in the first place such as the removal of malodour for instance.

Although there are various treatments, devices and systems commercially available to address the root of the air quality impairment, the present invention is concerned with a cost-effective device that is capable of both filtering the air to reduce the quantity of airborne pollutants and/or malodour also treating the air with an air treatment agent such as a fragrance and/or a malodour treatment agent, wherein the device is configured to operate more efficiently to improve the air quality.

### SUMMARY OF INVENTION

According to a first aspect of the present invention there is provided therefore an air treatment device comprising: a housing having at least one air inlet and at least one air outlet with at least two discrete air passageways therebetween; wherein in a first of said passageways there is located a fan and at least one air filter retaining means arranged to releasably retain, in use, an air filter within one passageway;
and wherein in a second of said passageways there is located at least one refill securing means arranged to releasably securing a refill of air treatment agent and emanation means in the unlit of one or more heaters;
and wherein, in use, airflow through said at least two passageways is separate.

Keeping the airflow separate is considered to be particularly advantageous and efficient for several reasons, in particular because accelerated airflow generated by the fan will not come into contact with the heater(s) thus will not require the heater(s) to use more energy in imparting a sufficient amount of heat toward the refill of air treatment agent. Additionally it will permit a user to operate the two functions of the device independently as necessary; this ability would not be possible if separated air passageways and airflows were not available.

Preferably the device is provided with a door in the housing to permit access to the interior of the housing.

Preferably the air filter retaining means are configured to move from a first position when the door is closed in which the air filter substantially completely obstructs said first air passageway to move to a second position when the door is open such that the air filter no longer substantially completely obstructs said first passageway.

Alternatively or additionally, the air filter retaining means are configured to move from a first position when the door is closed in which the air filter is substantially parallel to the at least one fan to move to a second position when the door is open such that the air filter is not substantially parallel to the at least one fan.

Known air filtering devices generally require the user to specifically remove an air filter from the device to inspect it and determine whether cleaning and/or replacement of the filter is necessary. In practice however, users typically do not perform this function on a routine basis thus causing a gradual degradation of the filter over time without the user being aware that the amount of airborne pollutants is not being substantially reduced. In contrast, users are significantly more attuned to replacing refills of air treatment agent.

The movement of the air filter held in the device by the retaining means when the door is moved by a user to the door's second position is considered to be particularly advantageous as the air filter will be presented for visual inspection to the user regardless of whether the user intended to inspect the filter or not. Although the user may not be able to perceive the improved air quality related to the reduction of airborne pollutants when using the device, such a presentation of the air filter for visual inspection to the user will permit the user to appreciate that they are improving the air quality by reducing the level of airborne pollutants in addition to any improvements in perceived air quality related to the emanation of air treatment agent into the surrounding environment.

Preferably the device is provided with a single air inlet and single air outlet, and preferably both of said air inlet and air outlet being covered by vents to object the access of large objects and improve the safe operation of the device when in use. Most preferably the device is provided with two air inlets and one air outlet.

Preferably the device has a single fan. Preferably the air is oriented to push/pull the air in a substantially upward direction relative to the surface on which the device is placed. Most preferably the fan is orientated at an angle of between 0°-40° relative to the surface on which the device is placed.

Preferably the device has guide means incorporated within the air filter retaining means. In this arrangement the location of an air filter within said retaining means can be made foolproof such that the filter can only retained by said retaining means when loaded in a specific orientation. Forcing a particular loading orientation on the air filter may be useful in ensuring the correct operation of the device in use and/or when using a multi-purpose filter having more than one filtering surface.

Preferably the air filter retaining means used in the device are configured to be capable of supporting substantially all of a perimeter portion of an air filter. This arrangement is considered to be beneficial in assisting the air filter in retaining its shape by providing structural support against the shear forces applied thereagainst by the operation of the fan. in use of the device.

Preferably the device has a single set of refill securing means. Alternatively the device has at least two sets of refill securing means and, in this alternative arrangement the at least two sets may be provided to releasably grip the neck portions of at least two refills, Preferably the one or more sets of securing means are configured to releasably grip a neck portion of a refill, such as a refill bottle or the like.

The device is preferably provided with a single door which, in an open position, is capable of providing access to both the air filter retaining means and the refill securing means.

Preferably the device permits movement of the releasable air filter via a pivoting mechanism, specifically, wherein the internal surface of the door is provided with a pair of projecting arms having pivot points at the remote end thereof, a pair of rods are pivotally connected respectively to said pivot points and the remote end of said rods are respectively pivotally connected to the air filter retaining means, and wherein a biasing spring is connected around one or both of said pivot points as well as bearing against the arms and rods. In the first position where the door is closed this arrangement causes the releasable air filter to retained substantially parallel and adjacent to the fan and, when the door is opened, this arrangement causes the air filter to move out of the parallel and adjacent relationship with the fan into a substantially perpendicular orientation and/or the position taken by the door in the closed position such that a planar surface of the filter can clearly be visible for inspection by a user.

Alternatively, the air filter retaining means may be mounted on the door of the housing such that said means project substantially perpendicularly relative to the longitudinally elongate shape of the door on the device. In this alternatively preferred arrangement, as the door is moved into the open position such that the door is substantially parallel with a surface on which the device is stood, the air filter will be orientated substantially perpendicular to said surface and thus be clearly visible for inspection by a user.

As a further alternative, the air filter and/or air filter retaining means may be in contact with both a biasing means and the door or a stop member in contact with the door in the first position such that the door or stop member opposes the force imposed by the biasing means on the air filter and or air filter retaining means. In this arrangement when in the second position with the door open the door or stop member is no longer in contact with, or no longer imparts a sufficient opposing force on, the air filter or air filter means such that the biasing means is able to urge the air filter or air filter means away from substantially completely obstructing the at least one air passageway. Preferably the biasing means is comprised of one of more springs located in the device substantially opposite the part of the air filter or air filter means that is in contact with the door or stop member in the first position.

Preferably the device is provided with a plurality of feet which are capable of raising the base of the device away from a surface on which the device is located and, in this arrangement, at least one of the air inlets is located in the base of the device.

Preferably the device is provided with guide means for the refill of air treatment agent to permit more convenient and user-friendly loading and unloading thereof. The device is preferably provided with a sufficiently sized recess or the like to permit ease of lateral access to the refill or refills when secured in the device to permit a user to sufficient mechanical grip on the refill(s) for convenient loading and unloading of said refill(s).

The door of the device is preferably provided with a window or the like in registration with the location of a refill when secured within the device in order to permit a convenient and inexpensive end of refill life guide for a user. Where the refill is a bottle of air treatment agent, such as a translucent glass or plastic bottle of agent with a wick disposed therein to transport the agent out of the bottle, a user would easily be able to see through the window or the like whether the refill has any agent remaining therein thus necessitating replacement or not thereof.

Preferably the device is, in use, to be used with a refill bottle(s) of air treatment agent, such as translucent glass or plastic bottle(s) of agent with a wick disposed therein to transport the agent out of the bottle(s).

Preferably the device is, in use, to be used with a single layer air filter, and even more preferably said device is, in use, to be used with a multi-layer air filter.

In a preferred embodiment the air filter is configured to impart the filter with at least one property of: a mechanical filter layer; an electrostatic filter layer; a malodour reducing layer; a pollutant reducing layer. Preferably the filter is provided with at least two of said properties, and even more preferably at least three of said properties, and yet even more preferably with at least four of said properties.

As mentioned above, in a particularly preferred embodiment the air filter is a multilayer air filter which is preferably provided with distinct layers possessing distinct properties. For instance the filter may comprise at least two types of filter layer, namely one or more mechanical filter layers and one or more electrostatic filter layers, and wherein said types of layers are adjacent to each other and oriented within the device such that the air must first pass through the mechanical filter layer(s) before passing through the electrostatic filter layer(s).

The air filter is preferably operable to remove at least some malodour from the air filtered therethrough when used as the filter in the device of the present invention; more preferably the filter is operable to remove at least 50% of the malodour filtered therethrough; even more preferably the filter is operable to remove at least 80% of the malodour filtered therethrough; and most preferably the filter is operable to remove substantially all of the malodour filtered therethrough.

Preferably the air filter for use with the present invention is capable of substantially completely removing at least one of the following types of air pollutants from the air filtered therethrough in use of the device, namely: malodour (including kitchen malodour and/or pet malodour and/or tobacco malodour), dust, smoke, pollen, bacteria, soot, mould spores, animal dander, microscopic irritants. More preferably the filter is capable of substantially completely removing at least two types of said air pollutants; even more preferably the filter is capable of substantially completely removing at least three types of said air pollutants; even more preferably still the filter is capable of substantially completely removing at least four types of said air pollutants; and most preferably the filter is capable of substantially completely removing all of said air pollutant types.

Preferably the device is, in use, to be powered via mains electricity, although the device could use any suitable power source such as batteries and/or solar panels or the like.

### BRIEF DESCRIPTION OF THE DRAWINGS

Embodiments of the invention will now be described, by way of example only, with reference to the following drawings in which:

FIG. 1 illustrates a perspective side elevation of the device in a first closed position; and

FIG. 2 illustrates a cutaway view of the device.

### DESCRIPTION OF AN EMBODIMENT

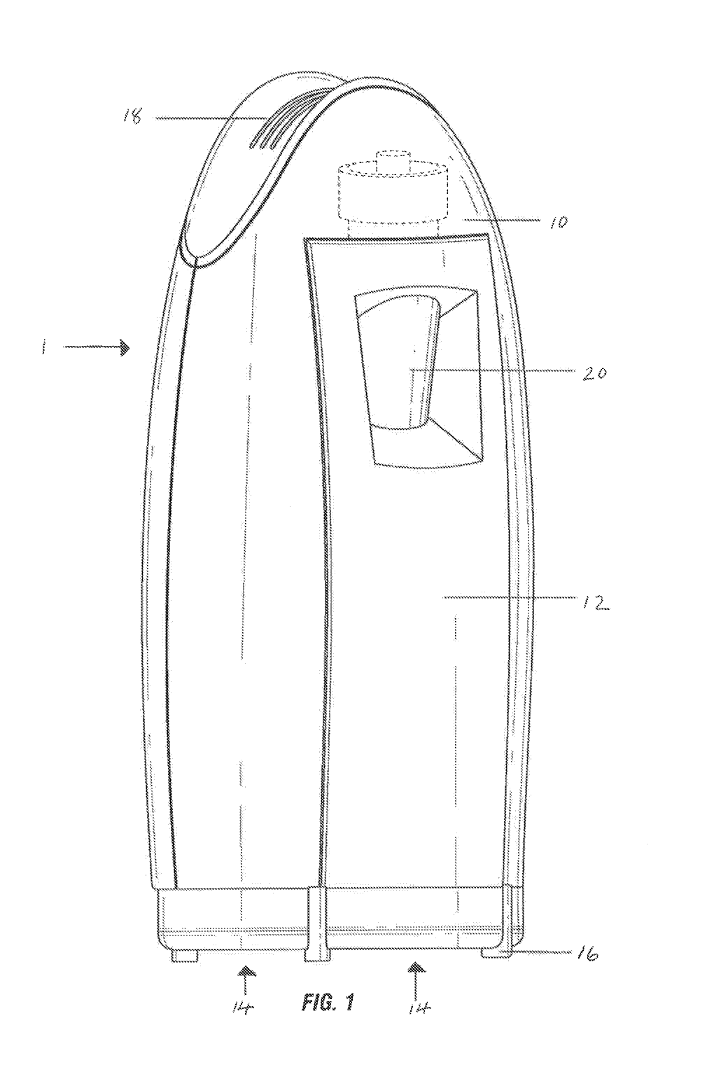

As can been seen with reference to both FIGS. 1 & 2, the device 1 of the present invention has a generally elongate housing 10 with an elongate door 12 therein. At the base of the device is an air inlet 14 which is spaced above a surface on which the device is to be placed during use thereof by a plurality of feet 16 protruding from the base. At the upper portion of the housing 10 is an air outlet 18.

The device 1 is illustrated with a bottle of air treatment agent 20 engaged therein. The bottle 20 is located within the device in registration with a window in the door 12 to conveniently permit a user of the device to determine the level of agent remaining in the bottle 20.

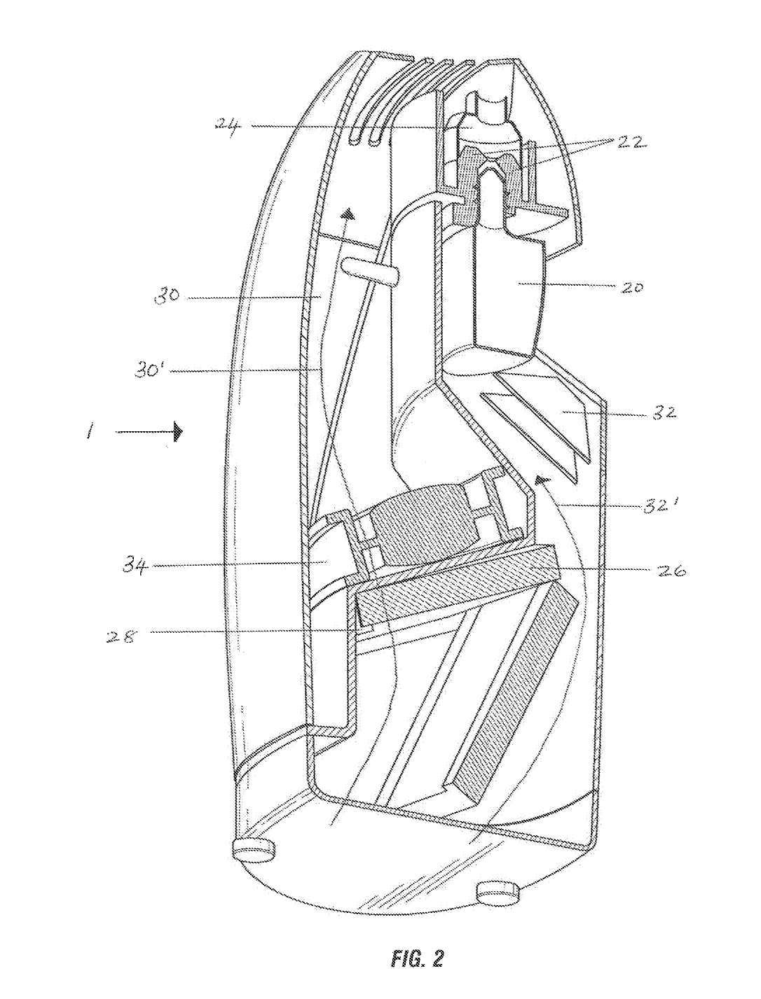

As can be seen with specific reference to FIG. 2, the bottle 20 is secured in the device via releasable engagement with securing means 22 which grip the neck of the bottle 20, this enables a wick (not shown) to protrude out of the top of the bottle 20 and into an aperture within a heater 24 located thereabove. The heater 24 has a looped shaped to surround the wick in order to uniformly apply heat toward the wick in use of the device.

The interior of the housing 10 is shown as defining two separate air passageways 30 & 32 where air moves in the direction of arrows 30′ & 32′. Within the first passageway 30 is the fan 34 and position beneath this is an air filter retain means 28 with an air filter 26 retained therein.

The air filter 26 is of a roughly square planar shape with sufficient depth to house one or more filtering materials. Although not illustrated the air filter 26 has at least two distinct types of filter layer, namely one or more mechanical filter layers and one or more electrostatic filter layers, and wherein said types of layers are adjacent to each other and oriented within the device such that the air must first pass through the mechanical filter layer(s) suitable for catching larger particles before passing through the electrostatic filter layer(s) suitable for catching the smaller particles. Although the mechanism is not fully understood, this arrangement also appears to be particularly effective at removing at least some malodour from the air filtered therethrough in use of the device.

Although not illustrated, the retaining means 28 are provided with guide means therein to permit foolproof loading of the air filter 26 in said means 28. The guide means force a particular loading orientation of the air filter 26 which is useful when the filter has different types of filter incorporated therein, thus for instance ensuring that larger particles are removed before the smaller particles are removed.

Although not clearly illustrated , the air filter retaining means 28 are provided in the form of an open framework configured to support substantially all of a perimeter portion of the air filter 26. The air filter 26 may also be provided with a framework around its perimeter portion to cooperate with the framework of the retaining means 28. This arrangement is considered to be beneficial in assisting the air filter 26 in retaining its shape by providing structural support against the shear forces applied thereagainst by the operation of the fan 34 in use of the device.

The fan 34 is oriented such that, in use of the device, it is operable to pull the air in a substantially upward direction through the air inlet 14 and the air filter before pushing the air in the direction of arrow 30′ toward the air outlet 18.

Air is also able to enter through the air inlet 14 and/or via a separate air inlet (not shown) to travel in the passageway 32 in the direction of arrow 32′ toward the heater 24. Airflow 32′ will take up the air treatment agent and exit the device via the air outlet 18. Keeping the airflow 30′ and 32′ separate is considered to be advantageous for several reasons, in particular as the heat applied by the heater 24 toward the wick of the refill will not be cooled by an increased airflow being pushed by the fan 34. Additionally, it will provide the user with the option of operating the two functions of the device independently as necessary, this ability would not be possible if separated air passageways 30, 32 and airflows 30′, 32′ were not available.

The device 1 illustrated is provided with an electric cord (not illustrated) with a plug formation at its remote end to power the device via mains electricity. However, the device could use any suitable power source such as batteries and/or solar panels or the like.

All of the features disclosed in this specification (including any accompanying claims, abstract and drawings), and/or all of the steps of any method or process so disclosed, may he combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An air treatment device comprising:
a housing having at least two air inlets and at least one air outlet with at least two discrete air passageways therebetween and a single fan;
wherein in a first of said passageways there is located said single fan and at least one air filter retaining means arranged to releasably retain, in use, an air filter within one passageway; and
wherein in a second of said passageways there is located at least one refill securing means arranged to releasably secure a refill of air treatment agent and emanation means in the form of one or more heaters;
and wherein, in use, airflow through said at least two passageways is separate such that airflow generated by the fan will not come into contact with the emanation means.

2. An air treatment device according to claim 1, wherein the device is provided with a door in the housing to permit access to the interior of the housing.

3. An air treatment device according to claim 1, wherein the air filter retaining means are configured to move from a first position when the door is closed in which the air filter substantially completely obstructs said first air passageway to move to a second position when the door is open such that the air filter no longer substantially completely obstructs said first passageway.

4. An air treatment device according to claim 1, wherein the air filter retaining means are configured to move from a first position when the door is closed in which the air filter is substantially parallel to the at to move to a second position when the door is open such that the air filter is not substantially parallel to the fan.

5. An air treatment device according to claim 1, wherein the device is provided with a single air inlet and single air outlet, and both of said air inlet and air outlet being covered by vents

6. An air treatment device according to claim 1, wherein the device has guide means incorporated within the air filter retaining means.

7. An air treatment device according to claim 1, wherein the air filter retaining means used in the device are configured to be capable of supporting substantially all of a perimeter portion of an air filter.

8. An air treatment device according to claim 1, wherein the device has a single set of refill securing means.

9. An air treatment device according to claim 1, wherein the device has at least two sets of refill securing means.

10. An air treatment device according to claim 1, wherein the device is provided with a single door which, in an open position, is capable of providing access to both the air filter retaining means and the refill securing means.

11. An air treatment device according to claim 1, wherein the device is provided with a plurality of feet which are capable of raising the base of the device away from a surface on which the device is located and at least one of the air inlets is located in the base of the device.

12. An air treatment device according to claim 1, wherein the device is provided with guide means for the refill of air treatment agent.

13. An air treatment device according to claim 2, wherein the air filter retaining means are configured to move from a first position when the door is closed in which the air filter substantially completely obstructs said first air passageway to move to a second position when the door is open such that the air filter no longer substantially completely obstructs said first passageway.

14. An air treatment device according to claim 2, wherein the air filter retaining means are configured to move from a first position when the door is closed in which the air filter is substantially parallel to the at least one fan to move to a second position when the door is open such that the air filter is not substantially parallel to the at least one fan.

15. An air treatment device according to claim 2, wherein the device is provided with a single air inlet and single air outlet, and both of said air inlet and air outlet being covered by vents

16. An air treatment device according to claim 2, wherein the device has guide means incorporated within the air filter retaining means.

17. An air treatment device according to claim 2, wherein the air filter retaining means used in the device are configured to be capable of supporting substantially all of a perimeter portion of an air filter.

18. An air treatment device according to claim 2, wherein the device is provided with a single door which, in an open position, is capable of providing access to both the air filter retaining means and the refill securing means.

19. An air treatment device according to claim 2, wherein the device is provided with a plurality of feet which are capable of raising the base of the device away from a surface on which the device is located and at least one of the air inlets is located in the base of the device.

20. An air treatment device according to claim 2, wherein the device is provided with guide means for the refill of air treatment agent.
